(19) United States
(12) Patent Application Publication
(10) Pub. No.: US 2025/0153924 A1
(43) Pub. Date: May 15, 2025

(54) PACKAGING, PACKAGING SYSTEM AND METHOD FOR CURED-IN-PLACE PIPE LINER SECTIONAL AND SPOT REPAIRS

(71) Applicant: Pipe Restoration, LLC, Aiken, SC (US)

(72) Inventor: Richard A. Fast, Aiken, SC (US)

(73) Assignee: Pipe Restoration, LLC, Aiken, SC (US)

(21) Appl. No.: 18/839,968

(22) PCT Filed: Feb. 21, 2023
(86) PCT No.: PCT/US23/62946

§ 371 Date: Aug. 20, 2024

Related U.S. Application Data
(60) Provisional application No. 63/312,270, filed on Feb. 21, 2022.

(51) Int. Cl. B65D 81/32; F16L 55/165

(52) U.S. Cl. CPC B65D 81/3266; F16L 55/165

(57) ABSTRACT

An apparatus, system and method are provided for packaging pipe repair components and using the packaging for cured in place pipe liner sectional spot repairs. The packaging has separate compartments each housing a pipe repair component including a pipe liner. The pipe liner is wet-out within the packaging with the pipe repair components from the other compartments in the packaging system.

### CROSS-REFERENCE TO RELATED APPLICATIONS

This application claims priority under 35 U.S.C. § 119 to provisional application Ser. No. 63/312,270 filed Feb. 21, 2022, which is incorporated by reference in its entirety.

### FIELD OF THE DISCLOSURE

The present disclosure relates to cured-in-place pipe (CIPP) liner repair. More particularly, but not exclusively, the present disclosure relates to packaging, a packaging system and method for cured-in-place pipe liner sectional and spot repairs.

### BACKGROUND

Pipe repair systems having a two-part epoxy resin usually require packaging the resin, hardener, and liner in individual packaging, then measuring and mixing the resin and hardener into a different container which can be messy and prone to error in the measurements and mixing. Moreover, wetting-out a liner with the mixed resin can be even more difficult, messy, and prone to errors, such as incorporating air bubbles into the repair and jeopardizing the ultimate integrity of the repair. Therefore, what is needed is packaging, a packaging system and method for cured-in-place pipe liner sectional and spot repairs that addresses these and other deficiencies.

### SUMMARY

Therefore, it is a primary object, feature, or advantage of the present disclosure to improve over the state of the art.

It is a further object, feature, or advantage of the present disclosure to package pipe repair components for CIPP pile liner section and spot repairs in a single package while separating the individual pipe repair components into compartments within the package until ready to be used.

It is a still further object, feature, or advantage of the present disclosure to provide openable barriers to separate the individual compartments.

Another object, feature, or advantage is to have a calibration roller configured as part of a rod and clamp barrier between compartments.

Yet another object, feature, or advantage is to provide for removal of the air bubbles from the wet-out liner prior to removal from the packaging.

Still another object, feature, or advantage is to provide a barriered packaging environment where pipe repair components are premeasured, combined, and wet-out a pipe liner.

An additional object, feature, or advantage is to provide packaging with compartments and openable barriers for controlling activating one pipe repair component with another pipe repair component.

In at least one aspect of the present disclosure, a packaging system for housing pipe repair components for cured in place pipe liner sectional and spot repairs is disclosed. The packaging system includes, for example, packaging with separate compartments housing pipe repair components and at least one of the compartments houses a pipe liner. The pipe liner is wet-out in the packaging with the pipe repair components from the other compartments.

In at least one other aspect of the present disclosure, packaging for cured in place pipe liner sectional and spot repairs is disclosed. The packaging includes, for example, separate compartments housing pipe repair components and at least one of the compartments houses a pipe liner. The pipe liner is wet-out in the packaging with the pipe repair components from the other compartments.

In yet another aspect of the present disclosure, a method for packaging pipe repair components and using packaging for cured in place pipe liner sectional and spot repairs is disclosed. The method includes, for example, the steps of providing packaging with separate compartments housing pipe repair components, wherein at least one of the compartments houses a pipe liner and combining the pipe repair components from the separate compartments together within the packaging to wet-out the pipe liner.

One or more of these and/or other objects, features, or advantages of the present disclosure will become apparent from the specification and claims that follow. No single embodiment need provide each and every object, feature, or advantage. Different embodiments may have different objects, features, or advantages. Therefore, the present disclosure is not to be limited to or by any objects, features, or advantages stated herein.

### BRIEF DESCRIPTION OF THE DRAWINGS

Illustrated embodiments of the disclosure are described in detail below with reference to the attached drawing figures, which are incorporated by reference herein.

FIG. 1 is a perspective view of packaging for CIPP pipe liner sectional and spot repairs in accordance with an exemplary aspect of the present disclosure;

FIG. 2 is another pictorial representation of packaging for CIPP pipe liner sectional and spot repairs;

FIG. 3A is a packaging system for housing pipe repair components for CIPP pipe liner sectional and spot repairs in accordance with an exemplary aspect of the present disclosure;

FIG. 3B is another pictorial representation of a packaging system for housing pipe repair components for CIPP pipe liner sectional and spot repairs;

FIG. 4 is a pictorial representation of openable barrier configured between compartments in accordance with an exemplary aspect of the present disclosure;

FIG. 5 is a pictorial representation of compartments in communication with each other in accordance with an exemplary aspect of the present disclosure;

FIG. 6 is a pictorial representation of a bleeder port for evacuating air from one or more of the compartments in accordance with an exemplary aspect of the present disclosure;

FIGS. 7A-7B are pictorial representations of packing systems for storing and combining pipe repair components in accordance with an exemplary aspect of the present disclosure;

FIG. 8 is a pictorial representation of a packing system of the disclosure and evacuating air from one or more of the compartments in accordance with an exemplary aspect of the present disclosure;

FIG. 9 is a pictorial representation of a packing system of the disclosure and mixing liquid from one or more of the compartments in accordance with an exemplary aspect of the present disclosure;

FIG. 10 is a flowchart for a method of packaging pipe repair components and using packaging for CIPP pipe liner sectional and spot repairs according to an exemplary aspect of the present disclosure; and

FIG. 11 is a flowchart of a method of packaging pipe repair components and using packaging for CIPP pipe liner sectional and spot repairs in accordance with another exemplary aspect of the present disclosure.

### DETAILED DESCRIPTION

The present disclosure relates to packaging, a packaging system, and method for cured-in-place (CIPP) pipe liner sectional and spot repairs, such as, for example, the repair of underground sewer, water, gas, or other suitable piping or conduit. In at least one example, liquid and solid pipe repair components are compartmentalized within packaging between, for example, openable barriers. Liquid pipe repair components can be combined within the packaging by opening one or more barriers. In some instances, one or more barriers are closed after combining the liquid pipe repair components. One or more of the liquid pipe repair components may be activated by the combination. The solid pipe repair component(s), such as a pipe liner, are combined with the liquid pipe repair components or a combination of the liquid pipe repair components are combined with the pipe liner in the same or separate compartment(s) of the packaging as part of a CIPP pipe liner sectional or spot repair.

In at least one aspect, packaging, a packaging system, and method are provided for a CIPP liner sectional repair system, or spot repair system, configured with a two-part resin and dry liner tube material all separately housed within packaging, the contents of which are combined within the packaging to be used for repairing an internal section of pipeline. Packaging, a packaging system, and method are provided for a CIPP liner sectional repair, or spot repair, that include openable barriers for separating each pipe repair component. The openable barriers separate each pipe repair material from interaction with the other components until such a time as it is desired to achieve the saturation, or wet-out, of the dry liner material. Packaging, a packaging system, and method are provided for a CIPP liner sectional repair, or spot repair, that is configured for vacuum impregnation of the dry material through use of a built-in vacuum attachment operably attached and in communication with one or more compartments of the packaging.

More specifically, the present disclosure relates to packaging, a packaging system, and method for packaging the multi-part resin and dry liner material in a single package that has separate compartments. The separate compartments may include a first compartment for housing a first pipe repair component. A second compartment housing a second pipe repair component and a liner compartment housing a pipe liner. A barrier between the first compartment and the second compartment is opened or removed and the pipe repair components are mixed while remaining fully contained within the packaging. A barrier disposed between the mixture of liquid pipe repair components and solid pipe repair components can be removed to combine the liquid and solid pipe repair components. For example, a barrier of the packaging can be opened whereby a mixture of liquid pipe repair components can be combined with a pipe liner in a pipe liner compartment allowing the blended pipe repair components to be pulled, pushed, or vacuum impregnated, into the pipe liner compartment to wet-out the pipe liner.

The present disclosure also relates to a method for packaging pipe repair components and using packaging for CIPP pipe liner section and spot repairs. The method may include creating the packaging system with separate compartments for housing each of the pipe repair components. A barrier can be removed between two compartments allowing the pipe repair components from each of the compartments to be combined within the packaging. Another barrier may be removed allowing additional pipe repair components such as the pipe liner to mix with the combined liquid pipe repair components. The pipe liner is wet-out with the combined pipe repair components and air is evacuated out of the packaging system or at least the compartment housing the pipe liner. The pipe liner is removed from the packaging system and applied to make a CIPP pipe liner sectional or spot repair.

The present disclosure also relates to a method for packaging pipe repair components and using the packaging for CIPP pipe liner section and spot repairs. A packaging system of pipe repair components for CIPP pipe liner section and spot repairs is ordered. A barrier between compartments housing individual pipe repair components within the packaging is opened, combining the individual pipe repair components from the separated compartments together. One of the individual pipe repair components activates the other pipe repair components. Any additional pipe repair components within the packaging systems are mixed or combined with the combined pipe repair components. The pipe liner within the packaging is wet-out with the activated combination of the other pipe repair components and air is evacuated from the packaging. The pipe liner is removed from the packaging and applied to make a CIPP pipe liner sectional or spot repair.

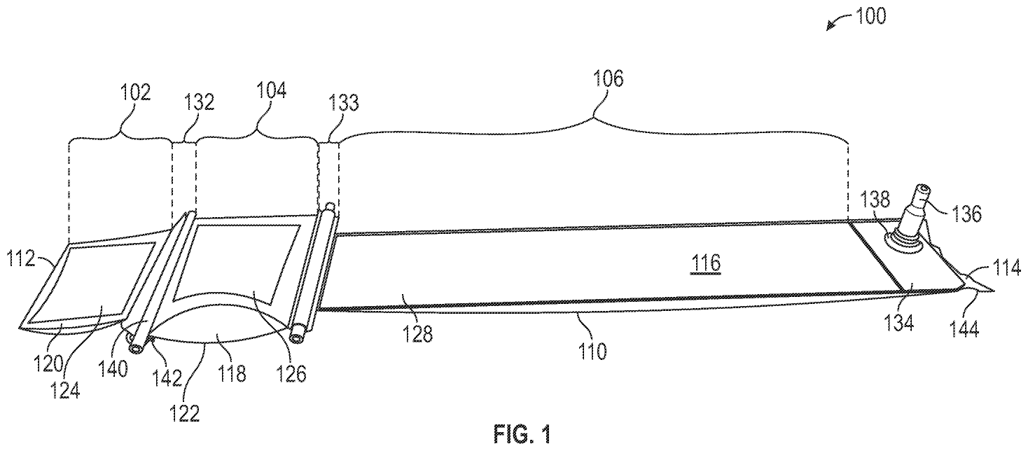

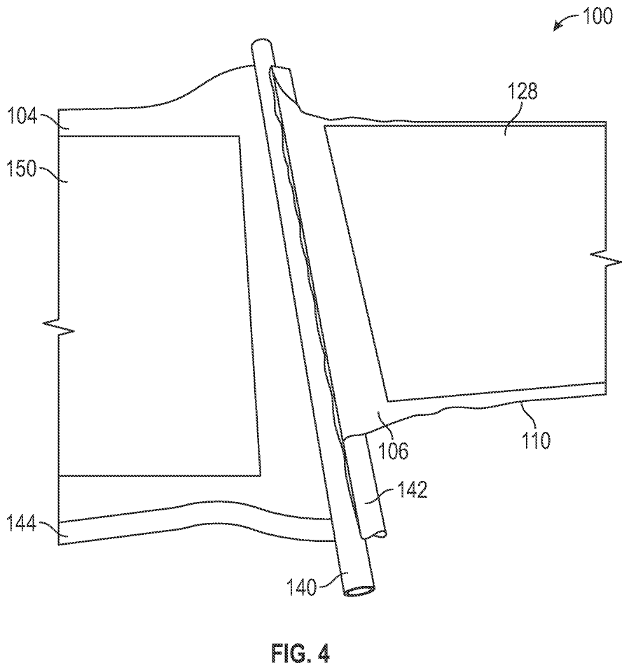

The CIPP sectional pipe and spot repair packaging, a packaging system, and method are provided illustratively in FIGS. 1-11. In at least one aspect, packaging, a packaging system, and method for CIPP pipe liner sectional and spot repairs is represented pictorially. The packaging system 100 can include packaging 110 with one or more liquid pipe repair components and one or more solid pipe repair components. The liquid pipe repair components can be combined to form a mixture of pipe repair components for use in wetting-out one or more solid pipe repair components, such as a pipe liner, for making CIPP pipe liner sectional and spot repairs. Packaging 110 can include one or more separate compartments for housing liquid pipe repair components, such as resin(s), hardener(s), dye(s), curing agent(s), or other liquid pipe repair components. Packaging 110 can include one or more separate compartments for housing solid pipe repair components, such as pipe liner(s), pipe repair tool(s), mixing tool(s) for liquid pipe repair components, or other suitable tool(s) for use with packaging 110 or removal of one or more wet-out pipe liner(s) from packaging 110. In one aspect, a packaging system 100 having packaging 110 with separate compartments, each housing a pipe repair component, is provided. Packaging 110 may include a first compartment 102 housing a first pipe repair component 124, a second compartment 104 housing a second pipe repair component 126, and a pipe liner compartment 106 housing a pipe liner 128. The packaging system 100 has a front side 120 opposing a back side 122, a first end 112 opposing a second end 114 and a top portion 116 opposing a bottom portion 118. In between the first end 112 and the second end 114, the packaging system 100 is divided into one or more or a plurality of compartments configured to store pipe repair components separately with the ability to mix the pipe repair components within one or more or a plurality of compartments once the barriers separating the compartment(s) are opened and/or removed. Barriers can also be closed or reinserted into the packaging 110 during mixing, movement of liquid and/or solid pipe repair components from one compartment to another or even within a compartment or a partitioned compartment, during wetting-out of the pipe liner 128, during evacuation of air bubbles, and during extraction of the wet-out liner(s) from packaging 110. Packaging 110 may be made of non-compostable, compostable, or other suitable types of material. In addition to being used as a carrier for both liquid and solid pipe repair components, packaging 110 can be used as part of and in the steps of the wetting-out process for wetting-out a pipe liner for making CIPP pipe liner section or spot repairs. Packaging 110 may be configured from specific types of material, such as those being suitable for use with specific types of liquid and solid pipe repair components. Example packaging 110 materials can include plastics, such as high density polyethylene (HDPE), low density polyethylene (LDPE), Polyethylene Terephthalate (PET, PETE), Polypropylene (PP), Polystyrene, Polyvinyl Chloride (PVC, Vinyl), or any other suitable type of packaging material that can store, protect, and be used to prepare components of pipe repair system 100. Packaging 110 can be configured to have one or more outer packaging layers and one or more inner packaging layers, such as a 2-PLY construction or multi-ply construction, that encapsulates the liquid and solid pipe repair components of the packaging system 100. Parts and materials of packaging 110 may be configured different than other parts and materials of packaging 110 to best house, protect, mix, move, prepare, or provide optimal results for preparing the pipe liner 128 for making CIPPP pipe liner section or spot repairs. For example, the inner packaging layer(s) may be configured with compartments for keeping each of the plurality of components of the pipe repair system 100 separate. The outer packaging layer(s) may be configured to provide additional protection from the effects of its environment and while the pipe repair system 100 is being transported, stored, and used. The outer packaging layer(s) may be configured to work in cooperation with the inner packaging layer(s) to provide additional protection from the environment, during transport, storage, and use. In some aspects, packaging 110 may be configured with one or more barriers for insulating the contents from environmental effects, such as from light, heat, humidity, pressure, or other effects. For example, packaging 110 can be configured with one or more light barriers to prevent one or more of the liquid pipe repair components from the effects of light, such as premature aging, activation, and/or curing. Packaging 110 may be constructed from material that is resistive to electrical conductivity, thermally conductivity, and solar radiation. Conversely, one or more parts of packaging 110 can be configured to be electrically conductive, thermally conductive, permissive of solar radiation or certain wavelengths of solar radiation. Conductivity or permissibility can be used to affect one or more of the individual or mixed liquid and/or solid pipe repair components or in the process of wetting-out a pipe liner.

The individual compartments of packaging may use different packaging 110 material(s), for example one compartment may be configured of a transparent plastic where the user of the pipe repair system 100 can see the component(s) and another compartment may be configured of a UV resistant material such as an opaque material that is a UV resistant plastic or other suitable material for preventing one or more of the liquid or solid pipe repair components from being affected from the environment, such as overexposure to light and/or heat that damages or causes liquid pipe repair component(s), such as a resin and/or a hardener, to not be optimal when used to wet-out a pipe liner 128. In at least one aspect, first end 112 of the pipe repair system 100 and the second end 114 of the pipe repair system 100 may be sealed by a heat barrier 144 such as through a multi-layer (e.g., material of one or more multiple material types) heat barrier 144.

The compartment 102 may be a liquid resin compartment. Compartment 102 may house a pipe repair component 124, such as a liquid resin. A pipe repair component 126, such as a liquid hardener, may be housed in compartment 104 and separated from compartment 102 by one or more barriers 132. The barrier(s) 132 can be opened and reclosed in at least one aspect. One or more barriers 132 can have a closed position. One or more barriers 132 can have an open position. One or more barriers of the packaging can be configured to remain closed during use. One or more barriers 132 can be frangible or rupturable. The pipe repair components 124, may include, resins, a resin additive such as a filler, stabilizer, color pigment, catalysts, accelerators, activators, or any other suitable resin additive(s) for the pipe repair system 100, a hardener, grease, lubricant, ink silicones, UV curable chemicals, or a sealant. The resin(s) can include polyester resins, phenolic resins, alkyd resins, polycarbonate resins, polyamide resins, polyurethane resins, silicone resins, epoxy resins, polyethylene resins, acrylic resins, polystyrene resins, polypropylene resins, or vinyl resins or any other types of resins.

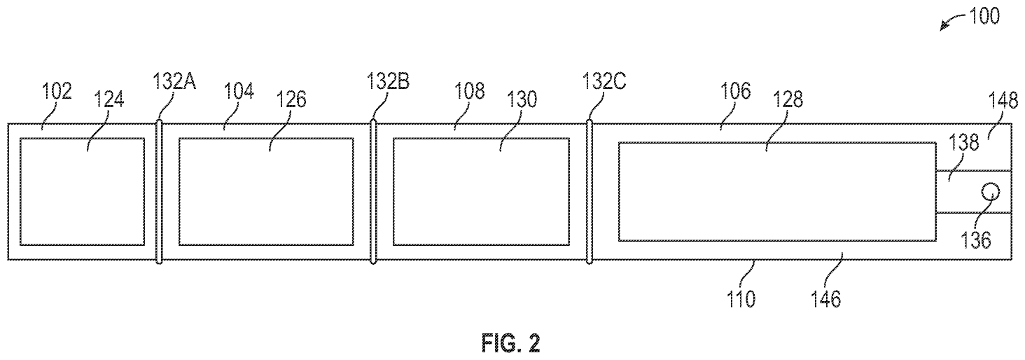

The packaging, a packaging system, and method for cured-in-place (CIPP) pipe liner sectional and spot repairs may have additional compartments 108, as shown, for example, in FIG. 2, for housing additional pipe repair components 130. The packaging, a packaging system, and method for cured-in-place (CIPP) pipe liner sectional and spot repairs may have additional compartments 108, as shown, for example, in FIG. 2, that are empty and configured for housing additional pipe repair components 130 that are introduced during use. The packaging, a packaging system, and method for cured-in-place (CIPP) pipe liner sectional and spot repairs may have additional compartments 108, as shown, for example, in FIG. 2, that are empty and configured to house a mixture of one or more pipe repair components 130 that are introduced from an external pipe repair component source during use or that are introduced from another compartment within the packaging. The packaging, a packaging system, and method for cured-in-place (CIPP) pipe liner sectional and spot repairs provides for the separated compartmentalization of various pipe repair components with content amounts and ratios configured to provide a variety of desired mixtures and repair results. For example, a pipe repair component 124 can be packaged at a 1:1, 2:1, 3:1 or any other ratio with respect to a pipe repair component 126 or any additional pipe repair component(s) 130. In some aspects of the present disclosure, the packaging may have a number of compartments, in addition to those shown. For example, packaging may be configured with multiple compartments, depending upon the number of pipe repair components. In at least one aspect, packaging can include 2-3 compartments, 3-4 compartments, 4-5 compartments, 5-6 compartments, or other additional compartments 108 for housing additional pipe repair components.

In at least one aspect of the disclosure, packaging 100 includes a liner compartment 106. The liner compartment 106 can be located at any location within packaging 100. In one configuration, liner compartment 106 is located within packaging 100 at or near one or more of the ends of the packaging 100. Liner compartment 106 can be located adjacent compartments 102, located adjacent compartment 104, located adjacent one or more other compartments, such as one of the additional compartments 108. The liner compartment houses the pipe liner 128. The pipe liner 128 can include a coated felt, uncoated felt, one, two layer, or multi-layer felt liner, fiberglass, films, barrier membranes, coated cloths, tarps, a metal or hard metal material such as basalt or carbide, ceramic materials, glass, components, rubber, polyethylene, fluoropolymers, plastic, or other suitable liner materials. In some aspects, the pipe liner 128 may include a liquid or powder that solidifies upon mixing with the other pipe repair components of the pipe repair system 100. The pipe liner 128 may also have an overlayment or underlayment of rods, wires, composite(s), or other suitable reinforcement structure to increase the stability of the liner. High-density polyethylene (HDPE) and ultrahigh molecular weight (UHMW) polyethylene provides excellent wear, low friction, and high toughness. Pipe liner 128 and pipe lining systems that are made of textiles may provide protection against wear, erosion and other environmental conditions while maintaining flexibility. The liner 128 may be constructed out of a tubular layer of non-woven polyester felt with an exterior polyurethane, polypropylene, or other suitable coating.

Each of the compartments 102, 104, and 108 and the liner compartment 106 may be separated from adjacent compartments by a barrier 132. The barrier 132 may be watertight or airtight to prevent the pipe repair components 124, 126, 130, and pipe liner 128 from mixing or blending until the barrier 132 is opened, broken, or removed. When it is time to mix the components 124, 126, 130, and pipe liner 128 from one compartment with another or adjacent compartment, the barrier 132 may be removed, broken, or punctured to allow one or more components 124, 126, 130, and pipe liner 128 to mix, such as component 124 from compartment 102 and component 126 from compartment 104. The barrier 132 may be configured of a pressure barrier, rods and clips, rods and clamps, clips, valves, plugs, removable dividers, frangible barriers, heat barriers, bleeder ports, a gasket cap with a rubber bleeder, or any other type or barrier or divider that allows the compartments 102, 104 and 108 and liner compartment 106 to be separate and barriered until it is time to mix one or more of the pipe repair components 124, 126, 130 from compartments 102, 104, 106, and 108 for making cured-in-place (CIPP) pipe liner sectional and spot repairs.

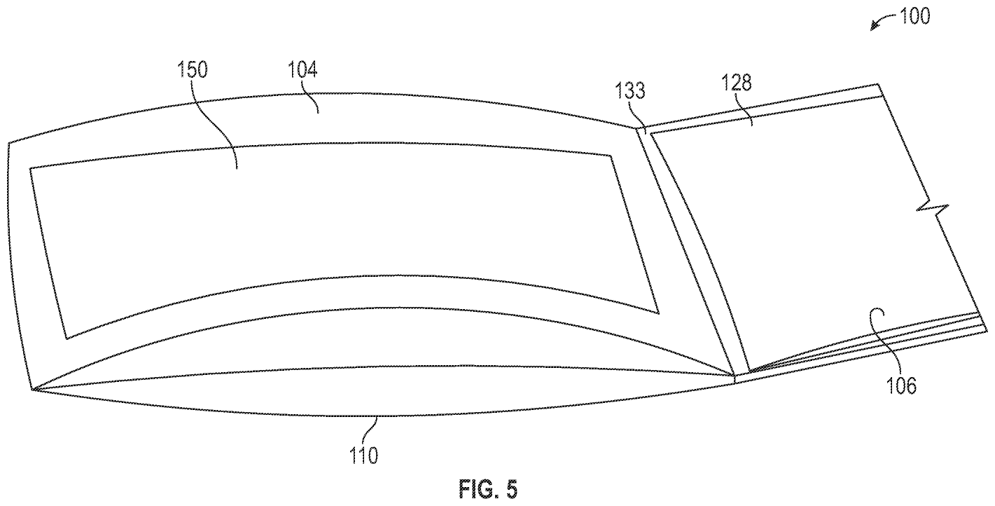

The barrier 132 may be a pressure release barrier 132, for example when enough pressure is applied to compartment 102 shown in the figures, the barrier 132 also shown in the figures may burst and be in the open position, as shown in FIG. 5, allowing pipe repair component 124 in compartment 102 to mix or blend with pipe repair component 126 shown in the figures in compartment 104 to create a blended pipe repair component 150, such as a curable resin. When the blended pipe repair component 150, as best shown in FIG. 5, is ready to mix with the pipe liner 128, the barrier 133 between compartment 104 and compartment 106 is opened and in a similar manner as barrier 132, whereby the blended component 150 is pushed, pulled, or flows into compartment 106 to wet out the pipe liner 128 in compartment 106. Barriers 132 and 133 are configured having sufficient resiliency to resist prematurely opening upon unintended impact that may occur while the pipe repair system 100 is being shipped, handled, or transported. In at least one aspect of the disclosure, a barrier is openable between at least two or more compartments whereby the two compartments are occupied by the collective contents of the two or more individual compartments. For example, barrier 132 can be opened whereby the space within compartments 102 and 104 can be used for performing the combination or housing the combined pipe repair components 124 and 126. Similarly, barrier 133 can be opened whereby the space within compartments 102, 104, and 106 can be used for performing the combination or housing the combined pipe repair components 124, 126, and 130 or pipe liner 128. For example, the pipe liner 128 can be wet out with the blended pipe repair component 150 in compartments 102, 104, and 106. Alternatively, the pipe liner 128 can be wet out with the blended pipe repair component 150 exclusively in compartment 106. In the case where barriers 132 and/or 133 are reclosable, pipe repair components may be moved individually or collectively from one compartment to another, where the evacuated compartment(s) is reclosed.

The barriers 132, 133 may be configured with a rod 140 and clamp 142. In one aspect, the rod 140 is placed on one side of the packaging and the clamp 142 is positioned on the opposing side of packaging 110. The rod 140 clips into the clamp 142 creating an airtight and watertight barrier for separating compartments and the pipe repair components in each compartment. Rod 140 and clamp 142 type barriers 132, 133 can configured for separating compartment 102 from compartment 104, compartment 104 from compartment 106, and compartment 102 from compartment 106. Similarly, rod 140 and clamp 142 type barriers can be configured between additional compartment 108 and the other compartments. The rod and clamp barriers may be made with industrial grade low-density polyethylene. The rod 140 may be configured using a calibration roller to aid in moving a pipe repair component from one compartment to another, mixing or blending of pipe repair components within one or more compartments, and wetting out pipe liner 128. For example, the calibration roller 140 may aid in pushing the blended component 150 into compartment 106 and/or onto the pipe liner 128. The rod or calibration roller 140 may also be used to evenly spread the blended component 150 along the pipe liner 128 for wetting out the liner 128.

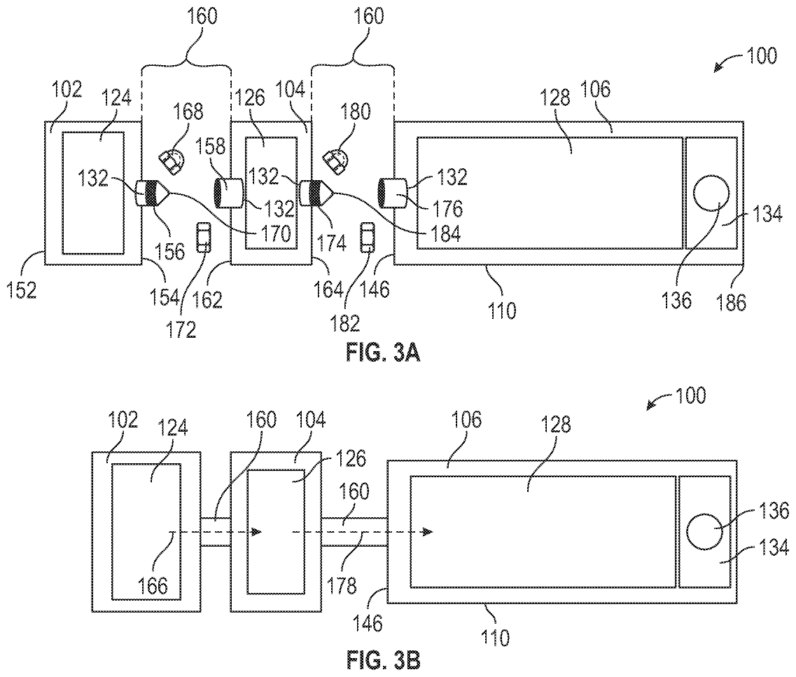

In addition to being separated from one another within packaging 110, pipe repair components may be separated by individual and separate compartments that may be tethered together, part of a kit, or entirely separate and separated by individual packaging, as shown in FIG. 3A and FIG. 3B. A removable barrier 132 having an open position, as shown in FIG. 3A, a closed position and a connected position, may be used to connect each individual package or compartment 102, 104, 106 or 108 with each other once the pipe repair components 124, 126, 130 and pipe liner 128 are ready to be combined and/or mixed. End 152 of compartment 102 or opposing end 154 of the compartment 102 may be configured with a removable barrier and a first connector 156 such as a screw and cap 168 for introducing pipe repair component 124 into compartment 102 or discharging or extracting pipe repair component 124 from compartment 102. For example, compartment 102 can be prefilled during package manufacturing or filled after package manufacturing with a desired amount of pipe repair component 124, the desired amount may be based on the size of the repair, desired adhesion properties, desired cure time, type of pile liner, atmospheric conditions, and the like or the type of could be based on the type of pipe repair component can be into allowing chemicals to be poured in prior to transport to the location where the pipe needs to be repaired. The screw cap may be configured to connect with the removable opening or second connector 158 on the second compartment 104 or the liner compartment 106 in the closed position. The first connector 156 or second connecter 158 can have a rubber bleeder allowing the chemical component to flow one way such as into the compartment while air flows out of the gasket cap removing air from the compartment 102, 104, or 108 when the barriers are in the connected positions.

By individually packing the components or at least one of the components the Pipe Repair system 100 system can increase the shelf life. This allows a user to purchase components individually and then connect the compartments in the proper order and mix the components, as shown in FIG. 3B when the barriers are in the connected position. For example, a user may select a system 100 with resin in the first compartment 102 permanently connected to the second compartment 104 comprising a hardener. The second compartment 104 is permanently connected to the liner compartment 106. The user may wish to add an attachable additional compartment 108 housing the additional component 130 such as a specific color of dye such as a dye that makes the resin more weather resistant to certain light spectrums, humidity resistant, chemically resistant, or other environmental qualities to extend the lifetime of the repair. The attachable additional component 130 may be a filler, stabilizer, color pigment or any other suitable resin additive for the pipe repair system 100, a hardener, grease, lubricant, ink silicones, UV curable chemicals or a sealant. The resin may be comprised of polyester resins, phenolic resins, alkyd resins, polycarbonate resins, polyamide resins, polyurethane resins, silicone resins, epoxy resins, polyethylene resins, acrylic resins, polystyrene resins, polypropylene resins or vinyl resins or any other types of resins.

The user may couple multiple compartments together using a coupling mechanism 160, as shown FIGS. 3A and 3B. The coupling mechanism may be located on the first compartment 102, the second compartment 104, any additional compartments or the pipe liner 128. In some aspects, some or all of the compartments 102, 104, 106, or 108 may have a coupling mechanism 160 allowing attachable additional compartment 108 to be attached to compartments 102, 104 or 108 or allowing the second compartment 104 to attach to the first compartment 102 and the liner compartment 106. In some aspects, all compartments 102, 104, or 106 and the liner compartment 106 may be detachable and attachable to each other as shown in FIG. 3A. This allows the different compartments to be attached in different orders. The first connector 156 couples to a second connector 158 located on the first side of the second compartment 162 opposing a second side of the second compartment 164. The first connector may couple to the second connector, such as by screwing on to the second connector when the barriers are in the connected position. The first pipe repair components flow 166 from the first compartment 102 through the first and second connectors 156, 158 and mix with the second pipe repair components 126. When the first connector 156 is not coupled to the second connector 158, the first connector may have a cap 168 covering the first connector 156 when the barrier is in the closed position. The first connector 156 may have a puncture apparatus 170 designed to puncture the barrier 132 at the base of the second connector 158. The second connector 158 has a cap 172 that couples to the second connector 158 when the second connector is not connected to the first connector 156.

The second side of the second compartment 164 may have a third connector 174 which couples to a fourth connector 176 located on the first side of the liner compartment 106, or additional compartments 108 having the same configuration. The components 126 or 150 flow from the second compartment 104 through the coupling mechanism 160 comprising the third connector 174 and fourth connector 176 and mix with the pipe liner 128 of the liner compartment 106. When the third connector 174 is not coupled to the fourth connector 176, the third connector 174 and fourth connector 176 may be covered with caps 180 and 182, respectively. The third connector may have a puncture apparatus 184 designed to puncture the barrier 132 at the base of the fourth connector 176. The barrier 132 at the base of the third connector 174 may be punctures by pressure.

The second end of the liner compartment 186 is the second end of the packaging 114 and closed with a heat barrier 144 as shown in FIGS. 1-3B and 6. A filter 134 is operatively connected to the liner compartment or the pipe liner to evacuate the air bubbles from the liner compartment during or after the wet out or impregnation of the pipe liner. The filter may be housed within the liner compartment and located near the second end of the liner compartment 186. The filter 134 may be comprised of felt, polyester blended fabric, fiberglass, cotton blended fabric, other cloth material, foam, paper, or any other material that functions as a filter 134. The filters 134 may be pleated or reusable. Air flows through the filter 134 and out through a vacuum port 136 or a bleeder valve 136. The filter 134 is a separation membrane or tool that allows air to be separated and removed from the liquid components. The filter 134 also prevents the liner compartment walls from collapsing around and closing of the vacuum port 136 and in the case of a bleeder valve 136 where pressure is applied to liner compartment walls to separate and discharge air leaving only liquid components and the pipe liner 128 within the compartment.

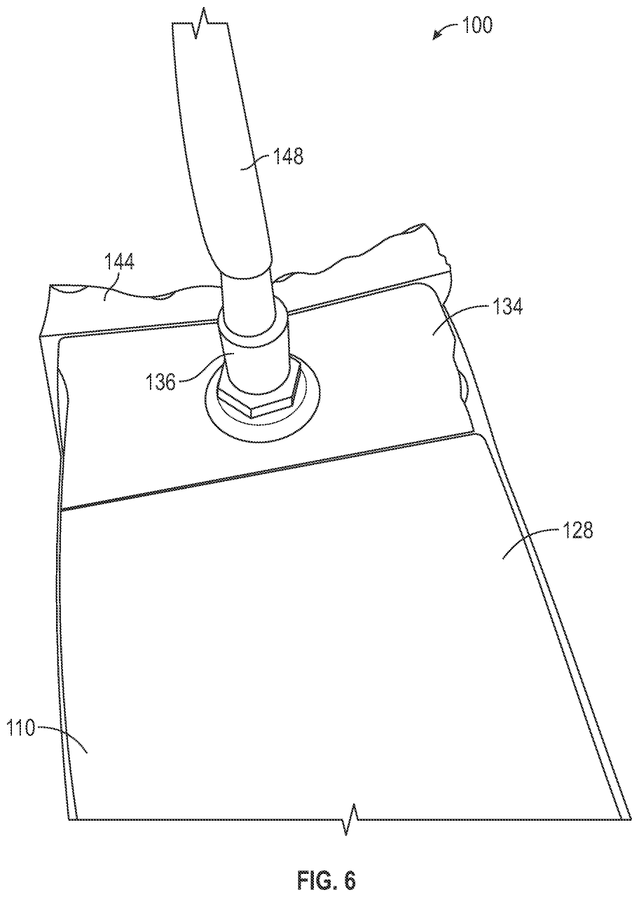

The bleeder port 136 or vacuum port 136 is located at the second end of the liner compartment 106. The vacuum port 136 allows air to be sucked out of the liner compartment 106 through the vacuum wick 138. After the barrier 132 is opened or removed between the liner compartment 106 and the second compartment 104 or additional compartment 108. The vacuum port 136 allows suctions the chemicals or components, such as the blended component 150 or blended resin 150, down to saturate the pipe liner 128. Air is evacuated from the from the liner compartment 106 in the part by using a deep vacuum. The liner compartment 106 is filled with blended resin 150 or other mixed chemicals 150 covering the pipe liner 128. The vacuum port 136 may aid in the removal of excessive blended component 150. The vacuum port 136 may be a pre-made port, a bleeder port or valve, a slit or cut in the liner compartment packaging where part of a vacuum or syringe can be inserted, a valve and a cap, a suction pump, or any other hole or port that is capable of removing air or drawing the blended resin towards the second end of the liner compartment. The air may be removed by an external vacuum connected to the vacuum port 136 through a vacuum hose 148 as shown in FIG. 6.

Air may also be removed chemically such as by deoxygenation. A chemical can be introduced into the liner compartment 106 through the vacuum port 136 or by attaching an additional compartment to the fourth connector 176. The chemical may be pushed, or gravity may be used to introduce the chemical into the liner compartment 106. The chemical may react with the components of the liner compartment 106 such as the blended component 150 to remove the air bubbles.

The rod portion 140 or calibration roller 140 of the barrier may be configured to act as a calibrated roller. The calibration roller 140 evenly distributes the blended components or chemicals along the pipe liner 128. The calibration roller 140 when paired with the vacuum port 136 provides uniform thickness of the blended components or chemicals throughout the length of the liner. It ensures that the liner has resin fully saturated throughout and that any entrained air in the lining material is evacuated through a vacuum wick 138 and out through the vacuum port.

Once all the air is out of the liner compartment 106 the pipe liner 128 can be removed and applied or cured to a pipe or a spot in need of repair. The pipe liner 128 may be removed by cutting or pushing the pipe liner 128 out or unfolding/unwrapping the liner from within the packaging of the packaging system 100.

In at least one aspect, a mechanical mixing input to one or more or all of the compartments can be provided for agitating the liquid contents or mixing liquid in one or more of the compartments or a single compartment or the compartment housing the pipe liner 128.

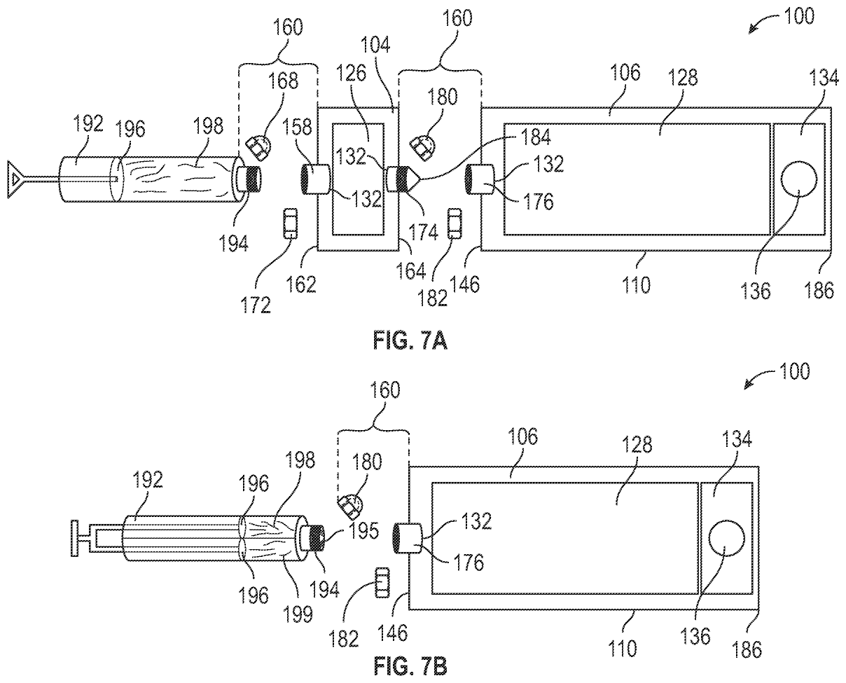

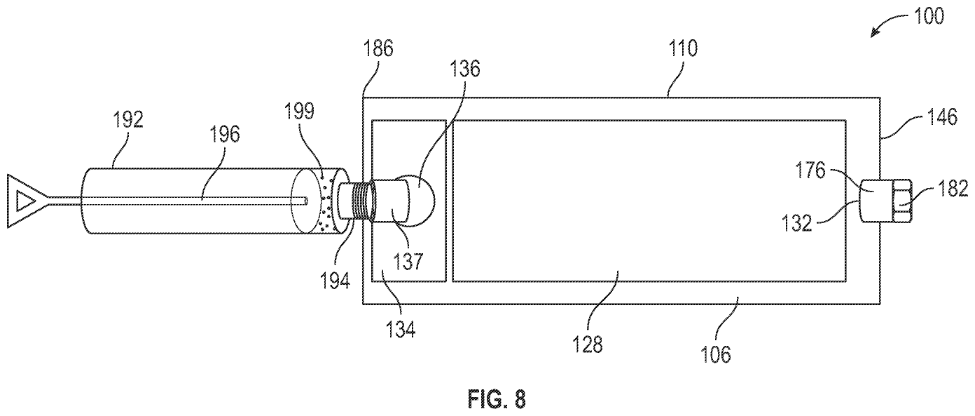

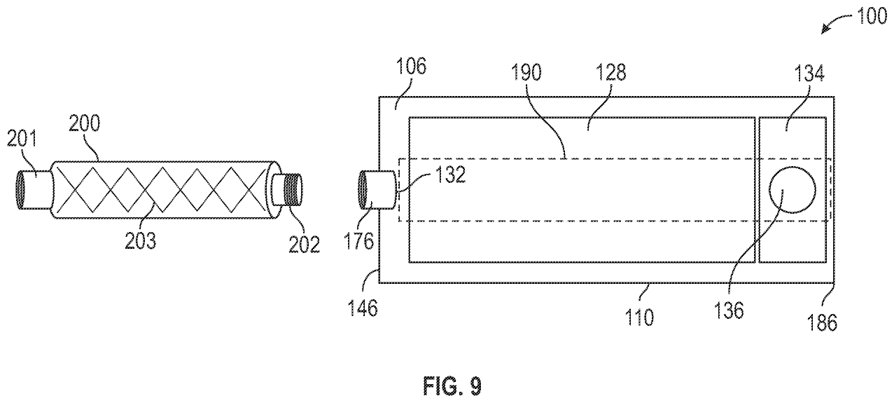

In at least one other aspect, a tube 192 (see, e.g., FIGS. 7A, 7B, 8), akin to a caulking tube, houses a resin or hardener or both in separated compartment within the tube and includes a fitting 194 for mating to a connector (e.g., 158, 176, or other compartment ingress points of the disclosure) for introducing the resin into one of the compartments (e.g., 126, 128, or other compartments of the disclosure) by inserting plunger 196. After discharging the contents of tube 192 into a compartment the process can resume as disclosed herein. For example, resin from tube 192 and hardener from another tube 192 can be injected into a compartment and mixed as disclosed herein. A tube 192 housing both the resin and the hardener can be injected into a compartment and mixed as disclosed herein. The fitting 194 may include one or more veins or channels 195 to promote mixing of the resin and hardener during discharge from the compartments in the tube 192. In one aspect, a static mixer 200, such as the one shown in FIG. 9, configured with mixing veins 203 may be operably connected by connecting fitting 201 to fitting 194 of tube 192 and fitting 202 of static mixer 200 to connector 176 of liner compartment 106 for mixing a two-part or multi-part liquid, such as resin from tube 192 and hardener from another tube 192, when introducing the mixed resin into compartment 104 or compartment 106. A commercially available static mixer is shown at the following internet address https://www.rhfs.com/inline-static-mixers.html. The static mixer 200 may also be connected between compartment 104 and compartment 106 in any aspect of the present disclosure to promote mixing of the liquids introduced into the liner compartment 106. For example, fitting 201 of static mixer 200 may be connected to connector 174 of compartment 104 and fitting 202 of static mixer 200 may be connected to connector 176 of liner compartment 106. Fittings (201, 202) suitable to connecting the static mixer are contemplated, including threaded fittings, compression fittings, sleeve/gasket fittings configured to reduce or eliminate the introduction of air when pulling a vacuum at vacuum port 136.

In one aspect, the evacuated tube 192 shown in FIG. 8 may be disconnected from the compartment (e.g., disconnected from a fitting such as connector 158, 176) and reconnected to a fitting 137 for evacuating air 199 from liner compartment 106. In at least one example, fitting 194 of discharged tube 192 may be connected to vacuum port 136 (e.g., see FIG. 8) via connector 137 for evacuating air 199 into tube 192 by withdrawing plunger 196. In one aspect, mixed resin and hardener wet out the pipe liner 128 and air is evacuated from the compartment by connecting spent tube 192 and withdrawing plunger 196. In one aspect, tube 192 may be configured for use with a commercial caulking gun (not shown).

In one aspect, the liner compartment 106 may also include a sleeve 190, for example, as shown in FIG. 9. The sleeve may be constructed of the same materials discloses herein as the compartments (e.g., compartment 102, 104, or 106). The sleeve may be sealed on both ends to prevent liquid within the liner compartment 106 from entering. The diameter of sleeve 190 corresponds to the diameter of the packer used for installation of pipe liner 128 and is selected based on the size of the packer and to be slightly large to function as a condom for the packer. For example, a sleeve 190 having a diameter of 3 inches may be inserted within liner compartment 128 for use with a 2 inch packer. The sleeve 190 is sealed on both ends with air removed beforehand and inserted into the liner compartment 106 with pipe liner 128, with the pipe liner 128 being folded as discussed herein. The pipe liner 128 and sleeve 190 together are inserted into the liner compartment 106 before the liner compartment is sealed. In this manner, sleeve 190 is disposed with the folded layers of the pipe liner 128 and remains sealed for later use outside liner compartment 106 after the pipe liner 128 has been completely wet out as discussed herein. Liner compartment 106 and sleeve are opened, such as by cutting the compartment 106 and sleeve 190 material. An end of the sleeve 190 is opened and a packer is inserted into the dry sleeve 190 housed within the liner compartment 106 thereby protecting the packer from any liquid materials on or from the wet out pipe liner 128 or from the liner compartment 106. The wet out pipe liner 128, sleeve 190 and packer may be removed from the liner compartment 106 and the wet out pipe liner 128 may be finished being installed onto the packer protected by sleeve 190.

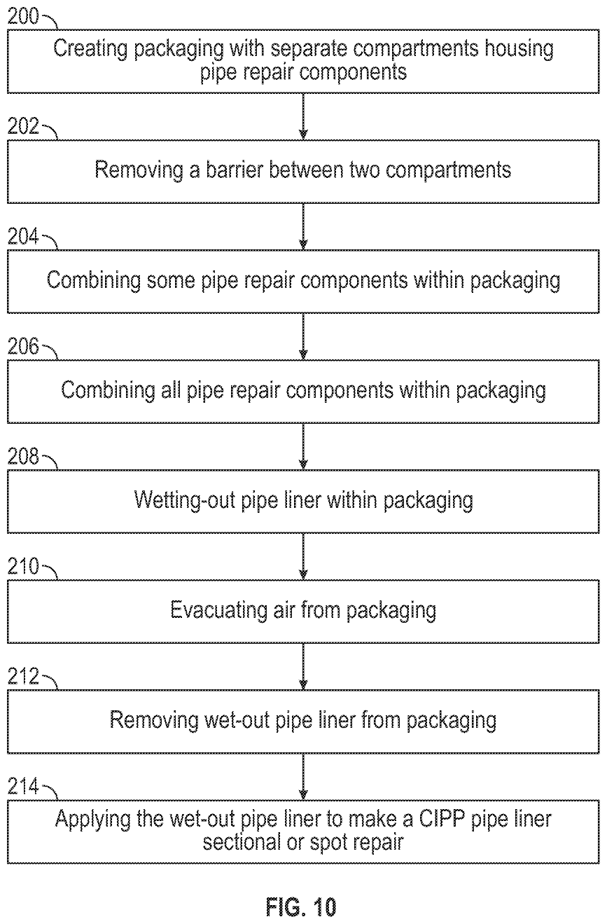

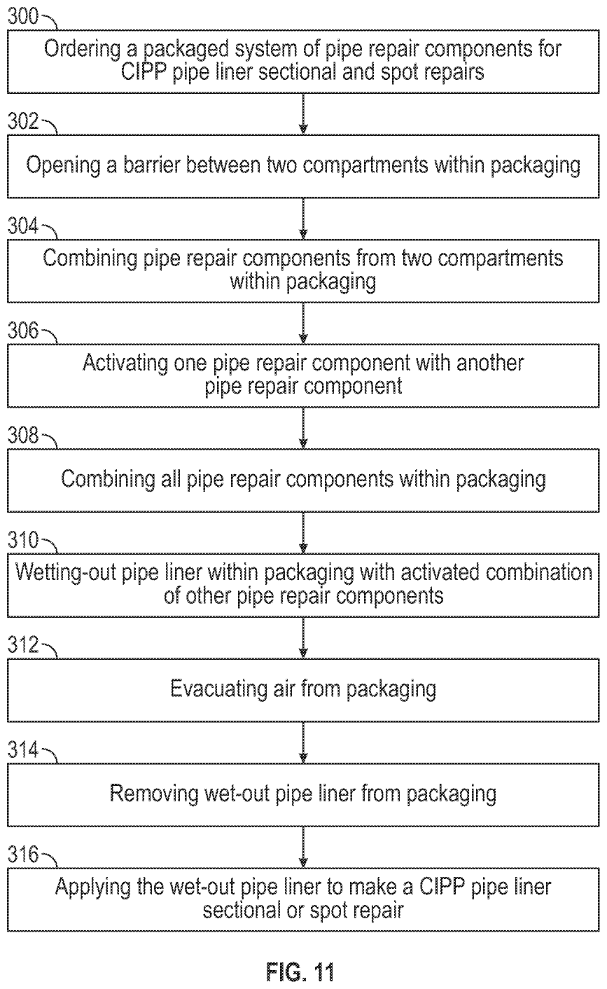

Exemplary methods of the disclosure for packaging pipe repair components and using the pipe repair packaging for cured in place pipe liner sectional and spot repairs are disclosed in FIGS. 10-11. Any methods relating to the disclosure of FIGS. 1-9 are incorporated into the methods disclosed herein. For example, the method for packaging pipe repair components and using the pipe may include a compartmentalized package with a two-part resin system and the dry fabric material, that when combined will form a hardened component liner within an internal area of a pipeline, resulting in the restructuring, or renewal, of that section of pipeline.

First, a package with separate compartments housing pipe repair components is created (Step 200). The first compartment 102, second compartment 104, any additional compartments and the liner compartment 106 are filled with the individual pipe repair components including a pipe liner 128 and barriers are placed in the closed position to separate the compartments. The first pipe repair component 124, such as a liquid resin is added to the first compartment 102, the second pipe repair component 126 is added to the second compartment 104 and the pipe liner 128 is added to the liner compartment 106. A barrier is placed in the closed position between the each of the compartments separating the compartments from each other. The barrier may be placed in the closed position prior to the individual pipe repair components being added to their respective compartments. The first end 112, bottom 118, and second side 114 of the packaging material 110 are sealed with a heat barrier 144.

In at least one aspect, the pipe liner 128 is folded in half and inserted into the liner compartment 106. For example, a 2 mm thick liner folded in half has a 4 mm thickness when inserted into the liner compartment 106.

The first compartment 102 is filled with the first pipe repair component 124. A barrier 132 is placed between the first compartment 102 and the second compartment 104. Then the second compartment 104 is filled with the second pipe repair component 126. A barrier 132 is placed in the closed position on another side of the second compartment 104 such as between the second compartment 104 and the liner compartment 106 to create a separation between the second compartment 104 and the liner compartment 106. The barrier 132 may create a separation between the second compartment 104 and an additional compartment 108. The pipe liner 128 is placed in the liner compartment 106 along with the filter 134. The liner compartment 106 is sealed and pipe repair system 100 is ready for transport to the repair location if necessary. The creation of the pipe repair packaging system may occur in reverse.

Next, a barrier between two compartments is removed (Step 202). The first removable barrier 132A between the first compartment 102 and the second compartment 104 is removed or placed in the open position combining the first compartment and the second compartment. The barrier may be a pressure barrier. The user places enough pressure on the first compartment 102 or the first removable barrier 132A causing the first removable barrier 132A to burst. If the barrier 132 is a rod and clamp barrier the user removes the clamp or clip from the rod thereby removing the barrier 132 between the first compartment 102 and the second compartment 104.

Next, some of the pipe repair components are combined (Step 204). The first component 124 of the first compartment 102 and the second component 126 of the second compartment 104 are combined or blended. The blending may occur by hand mixing, use of the calibration roller 140 or by any other means of blending the first component 124 with the second component 126 to create a blended component 150 or curable resin. The first component 124, such as a resin, enters the second compartment 104 after the barrier 132A is opened and mixes with the second component 126, such as a hardener. The first component 124 may be pushed into the second compartment 104 by the rod portion 140 of the first removable barrier 132A or a user may push the first component 124 into the second compartment 104. The rod 140 may be used to blend the first component 124 with the second component 126.

The first component 124 and second component 126 may use the combined first compartment 102 and second compartment 104 for mixing, or the barrier may be placed back in the closed position after the first pipe repair component enters the second compartment wherein the blending occurs within the second compartment. After mixing the first component 124 with the second component 126, a blended component 150 or curable resin is formed. The blended component 150 may be required to sit for a period of time allowing the first component 124 and second component 126 to become fully blended or any necessary chemical reactions to finish occurring. This step may also include the removal of the barrier 132 between the second compartment 104 and additional compartments 108 and the blending of the components in the additional compartments with the blended component 150.

Next, all pipe repair components are combined within the packaging (Step 206). The barrier between the second compartment 104 and liner compartment 106 may be removed allowing all pipe repair components to be combined. The blended component 150 or individual components are pushed into the liner compartment 106. The blended component 150 enters the liner compartment 106 after the barrier 132 bursts. The blended component 150 may be pushed into the liner compartment 106 by the rod 140 of the second barrier 132B or a user may push the blended component 150 into the liner compartment 106. After the blended component 150 enters the liner compartment 106, the barrier 132B may be placed back in between the second compartment 104 and the liner compartment 106 to decrease the amount of space the blended component 150 may use to wet the pipe liner 128.

Next, the pipe liner is wetted out within the packaging (Step 208). The blended component wets or saturates the pipe liner 128. A vacuum attached to the vacuum port 136 may draw the blended component 150 or curable resin into the liner and towards the filter 134 saturating and completely wetting out the pipe liner 128 and removing air thereby reducing the potential for failure points in the liner when installed. One or more calibrated rollers may be used to evenly wet out or saturate the pipe liner. A saturated pipe liner may require just enough catalyzed or curable resin to coat the pipe liner, so the pipe liner appears to be damp. After wetting the pipe liner 128 with the blended component 150, the liner compartment 106 may be required to sit for a period of time allowing the first component 124 and second component 126 to become fully blended or any necessary chemical reactions to finish occurring.

Next, air bubbles are evacuated from the packaging system 100 or the liner compartment 106 (Step 210). The air bubbles may be removed by connecting a hose of an external vacuum with the vacuum port 136 on the liner compartment 106 by vacuum impregnation. The vacuum is turned on and air is sucked out of the pipe compartment through the filter 134, which keeps the blended component in the liner compartment 106, the compartment walls from collapsing onto and blocking the vacuum port 136, and allowing air within the compartment to move out through the vacuum port. The rod 140 may be rolled over the liner compartment 106 to help push air and air bubbles towards the vacuum port 136 or bleeder port 136. When there is enough pressure within the packaging system the bleeder port 136 may open removing air from the packaging system while the wet-out liner stays inside the packaging system. In some aspects, a chemical may be introduced through the vacuum port 136 reacting with the chemicals of the blended component 150 or the air to remove the air from the liner compartment 106. After the air is removed the liner compartment 106 may be left for a certain amount of time, such as the length of time it takes the blended resin 150 to fully impregnate the pipe liner 128.

Next, the pipe liner 128 is removed from the liner compartment 106 and the packaging system and is ready to be used for repairing the pipe (Step 212). The liner may be removed by cutting the liner compartment 106 in half and removing the liner. An opening may also be cut on the second end of the liner compartment 106, the filter 134 is removed and the pipe liner 128 is pushed out of the liner compartment 106. Once the pipe liner 128 is removed, the pipe liner 128 may be applied to make a CIPP pipe liner sectional or spot repair (Step 214). The curable resin wetted on the liner may be cured during application.

In one aspect, the liner compartment 106 may also include a sleeve 190, for example, as shown in FIG. 9. The sleeve may be constructed of the same materials discloses herein as the compartments (e.g., compartment 102, 104, or 106). The sleeve may be sealed on both ends to prevent liquid within the liner compartment 106 from entering. The diameter of sleeve 190 corresponds to the diameter of the packer used for installation of pipe liner 128 and is selected based on the size of the packer and to be slightly large to function as a condom for the packer. For example, a sleeve 190 having a diameter of 3 inches may be inserted within liner compartment 128 for use with a 2 inch packer. The sleeve 190 is sealed on both ends with air removed beforehand and inserted into the liner compartment 106 with pipe liner 128, with the pipe liner 128 being folded as discussed herein. The pipe liner 128 and sleeve 190 together are inserted into the liner compartment 106 before the liner compartment is sealed. In this manner, sleeve 190 is disposed with the folded layers of the pipe liner 128 and remains sealed for later use outside liner compartment 106 after the pipe liner 128 has been completely wet out as discussed herein. Liner compartment 106 and sleeve are opened, such as by cutting the compartment 106 and sleeve 190 material. An end of the sleeve 190 is opened and a packer is inserted into the dry sleeve 190 housed within the liner compartment 106 thereby protecting the packer from any liquid materials on or from the wet out pipe liner 128 or from the liner compartment 106. The wet out pipe liner 128, sleeve 190 and packer may be removed from the liner compartment 106 and the wet out pipe liner 128 may be finished being installed onto the packer protected by sleeve 190.

In at least one aspect, the folded pipe liner 128 is wet out in the liner compartment 106 as disclosed herein. The setting on a wet out roller is set to the thickness of the folded pipe liner 128. A commercially available wet out roller is shown at the following internet address https://www.sle.co.uk/midi-roller-and-wet-out-station-bundle. For example, a 2 mm thick pipe liner 128 when folded in half has a 4 mm thickness, and thus would have a 4 mm thickness when removed from the liner compartment 106. The wet out roller setting can be set to 4 mm, the total thickness of the removed liner 128 to aid in completely wetting out the liner 128 with the blended resin 150. The wet out liner 128 may then be rolled onto a packer. A commercially available packer is shown at the following at the following internet address https://shop.sleonline.com/pipepatch-elbow-repair-packers. For example, the wet out liner 128 can be rolled onto a 2 inch packer, secured to the packer and installed in the pipe by inserting the wet out liner 128 into the pipe and inflating the packer at the repair site.

In another aspect the method for packaging pipe repair components and using the packaging or cured in place pipe liner section and spot repairs provides a compartmentalized packaging system with individual components that may be combined within the packaging system to create a CIPP section pipe repair and spot repair. First, a packaging system of pipe repair components for CIPP pipe liner section and spot repairs is order (Step 300). A user of the packaging system may go online or use the phone to order and ship the packaging system to the repair site or office of the repair man or contractor. During the ordering of the packaging system 100 the user ordering the packaging system may specify or customize the individual components 124, 126, 130 of each of the compartments, the number of compartments, the type of barrier, impregnation style or the type of air evacuation. The user may have to enter general or specific information about the repair if the components are premeasured. The packaging system 100 is created for the user of the systems and barriers 132 are placed to separate the components 124, 126, and 130. If the user does not customize the packaging system the user may order additional compartments to customize the packaging systems, such as the addition of a particular dye. The additional compartment 108 may come attached or the user may attach the additional compartment 108 later.

Next, a barrier between two compartments within the packaging system is opened (Step 302). The first removable barrier 132A between the first compartment 102 and the second compartment 104 may be opened combining the first compartment and the second compartment. The barrier may be a pressure barrier. The user places enough pressure on the first compartment 102 or the first removable barrier 132A causing the first removable barrier 132A to burst. When the barrier 132 is a rod and clamp barrier the user removes the clamp or clip from the rod thereby opening the barrier 132B between the first compartment 102 and the second compartment 104. The barrier between the liner compartment 106 and the second compartment 104 may be removed.

Next, pipe components from two compartments are combined within the packaging (Step 304). The first component 124 of the first compartment 102 and the second component 126 of the second compartment 104 are combined or blended. The blending may occur by hand mixing, use of the calibration roller 140 or by any other means of blending the first component 124 with the second component 126 to create a blended component 150 or curable resin. The first component 124, such as a resin, enters the second compartment 104 after the barrier 132A is opened and mixes with the second component 126, such as a hardener. The first component 124 may be pushed into the second compartment 104 by the rod portion 140 of the first removable barrier 132A or a user may push the first component 124 into the second compartment 104. The rod 140 may be used to blend the first component 124 with the second component 126.

The first component 124 and second component 126 may use the combined first compartment 102 and second compartment 104 for mixing, or the barrier may be placed back in the closed position after the first pipe repair component enters the second compartment wherein the blending occurs within the second compartment. After mixing the first component 124 with the second component 126, a blended component 150 or curable resin is formed. The blended component 150 may be required to sit for a period of time allowing the first component 124 and second component 126 to become fully blended or any necessary chemical reactions to finish occurring. This step may also include the removal of the barrier 132 between the second compartment 104 and additional compartments 108 and the blending of the components in the additional compartments with the blended component 150.

Next, one pipe repair component is activated with another pipe repair component (Step 306). When the first pipe repair component 124 mixes with the second pipe repair component 126, one of the pipe repair components becomes activated. If the first pipe repair component 124 is a liquid resin and the second pipe repair component 126 is a liquid hardener, mixing the two together prompts a chemical reaction transforming them into a solid 150 once a curing agent such as UV, temperature, or steam is introduced. One of the pipe components may be an activator or an accelerator to accelerate curing of the blended resin 150 when the curing agent is introduced. Catalyst or activator concentration determines the temperature, light, humidity, or another environmental condition at which the resin will chemically react to a cure. The activation may also be the start of the curing of the curable resin. The curing agent activates the resin causing it to harden, creating a fitted, smooth, and corrosion-resistant new pipe wall. Styrene based resins will not cure or harden until a catalyst is added. Catalyst concentration determines the temperature, light, humidity, or another environmental condition at which the resin will chemically react to a cure.

Next, all pipe repair components are combined within the packaging (Step 308). The barrier between the second compartment 104 and liner compartment 106 may be removed allowing all pipe repair components to be combined. The blended component 150 or individual components are pushed into the liner compartment 106. The blended component 150 enters the liner compartment 106 after the barrier 132 bursts. The blended component 150 may be pushed into the liner compartment 106 by the rod 140 of the second barrier 132B or a user may push the blended component 150 into the liner compartment 106. After the blended component 150 enters the liner compartment 106, the barrier 132B may be placed back in between the second compartment 104 and the liner compartment 106 to decrease the amount of space the blended component 150 may use to wet the pipe liner 128.

Next, the pipe liner is wetted out with the activated combination of other pipe repair components (Step 310). The blended component wets or saturates the pipe liner 128. A vacuum attached to the vacuum port 136 may draw the blended component 150 or curable resin towards the filter 134 saturating the pipe liner 128. One or more calibrated rollers 140 may be used to evenly wet out or saturate the pipe liner. A saturated pipe liner may require just enough catalyzed or curable resin to coat the pipe liner, so the pipe liner appears to be damp. After wetting the pipe liner 128 with the blended component 150, the liner compartment 106 may be required to sit for a period of time allowing the first component 124 and second component 126 to become fully blended or any necessary chemical reactions to finish occurring.

Next, air is evacuated from the packaging (Step 312). The air or air bubbles may be removed by connecting a hose of an external vacuum with the vacuum port 136 on the liner compartment 106 by vacuum impregnation. The vacuum is turned on and air is sucked out of the pipe compartment through the filter 134, which keeps the blended component in the liner compartment 106, and out of the vacuum port. The rod 140 may be rolled over the liner compartment 106 to help push air and air bubbles towards the vacuum port 136 or to remove the air bubbles entirely. A bleeder valve may be used to evacuate air from the packaging system. When there is enough pressure within the packaging system the bleeder valve may open removing air from the packaging system while the wet-out liner stays inside the packaging system.

Next, the wet-out pipe liner is removed from the packaging (Step 314). The wet-out pipe liner 128 may be removed by cutting open the packaging material 110, unwrapping the pipe liner 128 from the packaging material 128, opening the second end of the packaging system and pushing the liner out. Next, the wet-out pipe liner is applied to make a CIPP pipe liner sectional or spot repairs. Curing may occur during the application.

Although drawings and corresponding disclosure is provided, the disclosure for any one drawing is intended as disclosure for other drawings and methods. Features and functions and the corresponding descriptions are intended to apply across all of the exemplary representations provided in each drawing.

The disclosure is not to be limited to the particular embodiments described herein. In particular, the disclosure contemplates numerous variations in the CIPP Pipe Repair System 100 System, Apparatus and Method. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes, or methods of the disclosure. It is understood that any other modifications, substitutions, and/or additions can be made, which are within the intended spirit and scope of the disclosure.

What is claimed is:

1. A packaging system for housing pipe repair components for cured in place pipe liner sectional and spot repairs, comprising:
packaging with separate compartments housing pipe repair components;
at least one of the compartments houses a pipe liner;
wherein the pipe liner is wet-out in the packaging with the pipe repair components from the other compartments.

2. The packaging system of claim 1, further comprising:
openable barriers configured into the packaging between the separate compartments for combining the pipe repair components.

3. The packaging system of claim 1, wherein the pipe repair components comprise a liquid resin, a liquid hardener, and the pipe liner.

4. The packaging system of claim 1, wherein the separate compartments comprise a liquid resin compartment, a liquid hardener compartment, and a pipe liner compartment.

5. The packaging system of claim 1, further comprising:
a filter operably connected for evacuating air bubbles from one or more of the compartments.

6. The packaging system of claim 1, further comprising:
a bleeder port operably connected for evacuating air from the packaging.

7. The packaging system of claim 1, wherein at least two of the pipe repair components are combined before being combined with the pipe liner.

8. The packaging system of claim 1, wherein at least two of the pipe repair components comprise a curable resin when combined.

9. The packaging system of claim 1, wherein the pipe repair components are combined in one of the separate compartments.

10. The packaging system of claim 2, wherein the openable barriers have open and closed position for opening and closing communication between separate compartments.

11. The packaging system of claim 7, wherein at least one of the openable barriers is in the closed position for combining the pipe repair components.

12. Packaging for cured in place pipe liner sectional and spot repairs, comprising:
separate compartments housing pipe repair components; and
at least one of the compartments houses a pipe liner;
wherein the pipe liner is wet-out in the packaging with the pipe repair components from the other compartments.

13. The packaging of claim 12, further comprising:
openable barriers configured into the packaging between the separate compartments for combining the pipe repair components.

14. The packaging of claim 12, wherein the pipe repair components comprise a liquid resin, a liquid hardener, and the pipe liner.

15. The packaging of claim 12, wherein the separate compartments comprise a liquid resin compartment, a liquid hardener compartment, and a pipe liner compartment.

16. The packaging of claim 12, further comprising:
a bleeder valve for evacuating air from one or more of the compartments.

17. A method for packaging pipe repair components and using packaging for cured in place pipe liner sectional and spot repairs, comprising:
providing packaging with separate compartments housing pipe repair components, wherein at least one of the compartments houses a pipe liner;
combining the pipe repair components from the separate compartments together within the packaging to wet-out the pipe liner.

18. The method of claim 17, further comprising:
opening a barrier configured between the separate compartments for combining the pipe repair components.

19. The method of claim 17, further comprising:
combining at least two of the pipe repair components together before combining with the pipe liner.

20. The method of claim 17, further comprising:
evacuating air from one or more of the separate compartments for removing air bubbles from the wet-out pipe liner.

21. The method of claim 18, further comprising:
closing the barrier between one or more of the separate compartments after combining two or more of the pipe repair components.

22. The method of claim 17, further comprising:
removing the pipe liner wet-out with a curable resin from the packaging.

23. The method of claim 17, further comprising:
applying the pipe liner wet-out with the curable resin to make a cured in place pipe liner sectional or spot repair.
